(19) United States
(12) Patent Application Publication
(10) Pub. No.: US 2026/0117347 A1
(43) Pub. Date: Apr. 30, 2026

(54) CEMENTED CARBIDE AND CUTTING TOOL

(71) Applicant: SUMITOMO ELECTRIC HARDMETAL CORP., Itami-shi, Hyogo (JP)

(72) Inventors: Yasuki KIDO, Itami-shi, Hyogo (JP); Yuki TANAKA, Itami-shi, Hyogo (JP); Takahiro SEKIYA, Itami-shi, Hyogo (JP)

(73) Assignee: SUMITOMO ELECTRIC HARDMETAL CORP., Itami-shi, Hyogo (JP)

(21) Appl. No.: 19/143,902

(22) PCT Filed: Sep. 26, 2024
(86) PCT No.: PCT/JP2024/034433

§ 371 Date: Jun. 27, 2025

(51) Int. Cl. C22C 29/08; B23B 27/14; C22C 1/05; C22C 29/00; C22C 29/02; C22C 29/06

(52) U.S. Cl. CPC C22C 29/08; B23B 27/148; C22C 1/05; C22C 29/005; C22C 29/02; C22C 29/067

(57) ABSTRACT

A cemented carbide comprising a first hard phase and a binder phase, wherein a total content of the first hard phase and the binder phase is 80.0 vol % or more, a content of the binder phase is a range from 5.0 vol % to 21.0 vol %, a D50 of the binder phase is a range from 0.10 to 0.30 μm, a ratio D10/D90 is a range from 0.26 to 0.40, a vanadium content is a range from 0.01 mass % to 0.20 mass %, a chromium content is a range from 0.01 mass % to 1.00 mass %, in an interface region A, a ratio A_{V}/A_{Co} is a range from 0.01 to 0.5, a ratio A_{Cr}/A_{Co} is a range from 0.01 to 2.0, in an interface region C, a ratio B_{V}/B_{Co} is a range from 0.01 to 1.2, and a ratio B_{Cr}/B_{Co} is a range from 0.01 to 2.0.

### TECHNICAL FIELD

The present disclosure relates to a cemented carbide and a cutting tool.

### BACKGROUND ART

Conventionally, a cemented carbide including a plurality of tungsten carbide particles and a binder phase has been used for a material of a cutting tool (PTL 1).

### CITATION LIST

### Patent Literature

PTL 1: WO2023/228328

### SUMMARY OF INVENTION

A cemented carbide of the present disclosure is a cemented carbide comprising

a first hard phase consisting of a plurality of tungsten carbide particles and a binder phase containing cobalt, wherein a total content of the first hard phase and the binder phase of the cemented carbide is 80.0% by volume or more, a content of the binder phase of the cemented carbide is 5.0% by volume or more and 21.0% by volume or less, a cobalt content of the binder phase is 50% by mass or more, a 50% cumulative particle diameter D50 of the binder phase based on an area is 0.10 μm or more and 0.30 μm or less, a ratio D10/D90 of a 10% cumulative particle diameter D10 of the binder phase based on an area to a 90% cumulative particle diameter D90 of the binder phase based on an area is 0.26 or more and 0.40 or less, a vanadium content of the cemented carbide is 0.01% by mass or more and 0.20% by mass or less, a chromium content of the cemented carbide is 0.01% by mass or more and 1.00% by mass or less, the tungsten carbide particles include a first tungsten carbide particle having a crystal plane of {11-20} and a second tungsten carbide particle that exists adjacent to the crystal plane of {11-20}, in an interface region A between the crystal plane of {11-20} of the first tungsten carbide particle and the second tungsten carbide particle, a ratio A_{V}/A_{Co} of a maximum value A_{V} of the vanadium content to a maximum value A_{Co} of the cobalt content is 0.01 or more and 0.5 or less, in the interface region A, a ratio A_{Cr}/A_{Co} of a maximum value A_{Cr} of the chromium content to the maximum value A_{Co} of the cobalt content is 0.01 or more and 2.0 or less, the tungsten carbide particles include a third tungsten carbide particle having a crystal plane of {0001} and a fourth tungsten carbide particle that exists adjacent to the crystal plane of {0001}, in an interface region C between the crystal plane of {0001} of the third tungsten carbide particle and the fourth tungsten carbide particle, a ratio B_{V}/B_{Co} of a maximum value B_{V} of the vanadium content to a maximum value B_{Co} of the cobalt content is 0.01 or more and 1.2 or less, and in the interface region C, a ratio B_{Cr}/B_{Co} of a maximum value B_{Cr} of the chromium content to the maximum value B_{Co} of the cobalt content is 0.01 or more and 2.0 or less.

### BRIEF DESCRIPTION OF DRAWINGS

FIG. 1 is a diagram for describing a method for measuring A_{V}/A_{Co} and A_{Cr}/A_{Co} in an interface region A.

FIG. 2 is a schematic view of a cutting tool according to Embodiment 2.

### DETAILED DESCRIPTION

### Problem to be Solved by the Present Disclosure

From the viewpoint of cost reduction, there is a demand for a cemented carbide that can prolong a tool life, particularly even when it is used as a material for a cutting tool for rough processing of a die steel, and a cutting tool including the same.

### Advantageous Effect of the Present Disclosure

According to the present disclosure, it is possible to provide a cemented carbide that can prolong a tool life, particularly even when it is used as a material for a cutting tool for rough processing of a die steel, and a cutting tool including the same.

### Description of Embodiments

First, aspects of the present disclosure will be listed and described.

(1) A cemented carbide of the present disclosure is a cemented carbide comprising a first hard phase consisting of a plurality of tungsten carbide particles and a binder phase containing cobalt, wherein a total content of the first hard phase and the binder phase of the cemented carbide is 80.0% by volume or more, a content of the binder phase of the cemented carbide is 5.0% by volume or more and 21.0% by volume or less, a cobalt content of the binder phase is 50% by mass or more, a 50% cumulative particle diameter D50 of the binder phase based on an area is 0.10 μm or more and 0.30 μm or less, a ratio D10/D90 of a 10% cumulative particle diameter D10 of the binder phase based on an area to a 90% cumulative particle diameter D90 of the binder phase based on an area is 0.26 or more and 0.40 or less, a vanadium content of the cemented carbide is 0.01% by mass or more and 0.20% by mass or less, a chromium content of the cemented carbide is 0.01% by mass or more and 1.00% by mass or less, the tungsten carbide particles include a first tungsten carbide particle having a crystal plane of {11-20} and a second tungsten carbide particle that exists adjacent to the crystal plane of {11-20}, in an interface region A between the crystal plane of {11-20} of the first tungsten carbide particle and the second tungsten carbide particle, a ratio A_{V}/A_{Co} of a maximum value A_{V} of the vanadium content to a maximum value A_{Co} of the cobalt content is 0.01 or more and 0.5 or less, in the interface region A, a ratio A_{Cr}/A_{Co} of a maximum value A_{Cr} of the chromium content to the maximum value A_{Co} of the cobalt content is 0.01 or more and 2.0 or less, the tungsten carbide particles include a third tungsten carbide particle having a crystal plane of {0001} and a fourth tungsten carbide particle that exists adjacent to the crystal plane of {0001}, in an interface region C between the crystal plane of {0001} of the third tungsten carbide particle and the fourth tungsten carbide particle, a ratio B_{V}/B_{Co} of a maximum value B_{V} of the vanadium content to a maximum value B_{Co} of the cobalt content is 0.01 or more and 1.2 or less, and in the interface region C, a ratio B_{Cr}/B_{Co} of a maximum value B_{Cr} of the chromium content to the maximum value B_{Co} of the cobalt content is 0.01 or more and 2.0 or less.

In the crystallographic description in the present disclosure, an individual orientation is indicated by [ ], a family of orientations are indicated by < >, an individual plane is indicated by ( ) and a family of planes are indicated by { }, respectively. In addition, a crystallographic index that is negative is usually expressed by adding a “-” (bar) above the number, but in the present disclosure, a negative sign is added in front of the number.

According to the present disclosure, it is possible to provide a cemented carbide that can prolong a tool life, particularly even when it is used as a material for a cutting tool for rough processing of a die steel. The reasons for this are presumed to be as follows.

The cemented carbide of the present disclosure contains a first hard phase consisting of tungsten carbide particles and a binder phase containing cobalt in a total amount of 80.0% by volume or more, the content of the binder phase of the cemented carbide is 5.0% by volume or more and 21.0% by volume or less, and the cobalt content of the binder phase is 50% by mass or more. This allows the cemented carbide to have hardness and toughness suitable for cutting tools.

In the cemented carbide of the present disclosure, the D50 of the binder phase is 0.10 μm or more and 0.30 μm or less, and the D10/D90 of the binder phase is 0.26 or more and 0.40 or less. This allows a fine binder phase in the cemented carbide to be uniformly dispersed without being locally aggregated, and the cemented carbide structure is likely to be homogenous. Therefore, a cutting tool including a cutting edge consisting of the cemented carbide can have a stable chipping resistance.

The vanadium content of the cemented carbide of the present disclosure is 0.01% by mass or more and 0.20% by mass or less. Vanadium has the action of suppressing grain growth of tungsten carbide particles. When the vanadium content of the cemented carbide is 0.01% by mass or more, it is possible to effectively suppress the generation of coarse grains in the cemented carbide. When the vanadium content of the cemented carbide is 0.20% by mass or less, a vanadium concentrated layer in which vanadium is present in a concentrated manner is less likely to be formed in an interface region between WC particles and the reduction of the interface strength is likely to be suppressed. Therefore, the hardness and the strength of the cemented carbide are improved, and the wear resistance and the breakage resistance of the cutting tool that includes the cutting edge consisting of the cemented carbide are improved.

The chromium content of the cemented carbide of the present disclosure is 0.01% by mass or more and 1.00% by mass or less. Chromium has the action of suppressing grain growth of tungsten carbide particles. When the chromium content of the cemented carbide is 0.01% by mass or more, it is possible to effectively suppress the generation of coarse grains in the cemented carbide. When the chromium content of the cemented carbide is 1.00% by mass or less, a chromium concentrated layer in which chromium is present in a concentrated manner is less likely to be formed in an interface region between WC particles and the reduction of the interface strength is likely to be suppressed. Therefore, the hardness and the strength of the cemented carbide are improved, and the wear resistance and the breakage resistance of the cutting tool that includes the cutting edge consisting of the cemented carbide are improved.

In the interface region A of the cemented carbide of the present disclosure, the A_{V}/A_{Co} is 0.01 or more and 0.5 or less, and the A_{Cr}/A_{Co} is 0.01 or more and 2.0 or less. Moreover, in the interface region C of the cemented carbide of the present disclosure, the B_{V}/B_{Co} is 0.01 or more and 1.2 or less, and the B_{Cr}/B_{Co} is 0.01 or more and 2.0 or less. This suppresses formation of a vanadium concentrated layer and a chromium concentrated layer in the interface region A and the interface region C. Therefore, reduction of the interface strength between WC particles caused by the vanadium concentrated layer and the chromium concentrated layer is suppressed. Therefore, in the cemented carbide, WC particles are less likely to fall off due to reduction of the interface strength, and the occurrence of wear originating from chipping is suppressed in the cutting tool that includes the cutting edge consisting of the cemented carbide.

(2) In the above (1), the A_{V}/A_{Co} may be 0.01 or more and 0.3 or less, the A_{Cr}/A_{Co} may be 0.01 or more and 1.5 or less, the By/B_{Co} may be 0.4 or more and 1.2 or less, and the B_{Cr}/B_{Co} may be 0.5 or more and 2.0 or less.

When the A_{V}/A_{Co} and the A_{Cr}/A_{Co} fall the above ranges, formation of the vanadium concentrated layer and the chromium concentrated layer in the interface region A is further suppressed. Therefore, reduction of the interface strength between WC particles caused by the vanadium concentrated layer and the chromium concentrated layer is further suppressed. Therefore, the occurrence of wear originating from chipping is further suppressed in the cutting tool that includes the cutting edge consisting of the cemented carbide.

In the interface region C, V and Cr are generally more easily concentrated than in the interface region A. However, when the By/B_{Co} and the B_{Cr}/B_{Co} fall the above ranges, formation of the vanadium concentrated layer and the chromium concentrated layer in the interface region C is further suppressed. Therefore, reduction of the interface strength between WC particles caused by the vanadium concentrated layer and the chromium concentrated layer is further suppressed. Therefore, the occurrence of wear originating from chipping is further suppressed in the cutting tool that includes the cutting edge consisting of the cemented carbide.

(3) In the above (1) and (2), the cemented carbide further comprises a second hard phase, the second hard phase consists of at least one first compound selected from the group consisting of TiNbC, TiNbN, and TiNbCN, and a 50% cumulative particle diameter D50 of the second hard phase based on an area may be 0.003 μm or more and 0.05 μm or less. This further improves the hardness of the cemented carbide. Therefore, the cutting tool that includes the cutting edge consisting of the cemented carbide can have more excellent wear resistance.

(4) In any of the above (1) to (3), a mode of the tungsten carbide particles based on an area in particle size distribution may be 0.2 μm or more and 0.8 μm or less. This further improves the hardness of the cemented carbide. Therefore, the cutting tool that includes the cutting edge consisting of the cemented carbide can have more excellent wear resistance.

(5) The cutting tool of the present disclosure is a cutting tool that includes a cutting edge consisting of the cemented carbide according to any of the above (1) to (4). The cutting tool of the present disclosure can have a longer life, particularly even when it is used for rough processing of a die steel.

### DETAILS OF THE EMBODIMENTS OF THE PRESENT DISCLOSURE

With reference to the drawings, specific examples of the cemented carbide and the cutting tool according to the present disclosure will be described below. In the drawings of the present disclosure, the same reference signs represent the same portions or equivalent portions. In addition, a dimensional relationship such as length, width, thickness, or depth is appropriately changed for clarity and simplification of the drawings, and does not necessarily represent an actual dimensional relationship.

As used in the present disclosure, the expression of the format “A to B” means A or more and B or less, and when no unit is written in A and a unit is only written in B, the unit for A and the unit for B are the same.

As used in the present disclosure, when a compound or the like is represented by a chemical formula, if the atomic ratio is not particularly limited, the chemical formula shall include all conventionally known atomic ratios, and should not necessarily be limited only to those within the stoichiometric range.

As used in the present disclosure, when one or more numerical values are written as each of the lower limit and the upper limit of a numerical range, a combination of any one numerical value written as the lower limit and any one numerical value written as the upper limit shall also be disclosed.

In this disclosure, “comprise,” “include,” “have,” and variations thereof are open-ended terms. The open-ended terms may or may not include an additional element in addition to the required elements. The description of “consists of” is a closed term. However, even if a configuration is expressed in the closed term, it may include an additional element that is normally associated impurities or that is unrelated to the target technology.

### Embodiment 1: Cemented Carbide

A cemented carbide of one embodiment (hereinafter also referred to as “Embodiment 1”) of the present disclosure is a cemented carbide that includes a first hard phase consisting of a plurality of tungsten carbide particles and a binder phase containing cobalt. A total content of the first hard phase and the binder phase of the cemented carbide is 80.0% by volume or more. A content of the binder phase of the cemented carbide is 5.0% by volume or more and 21.0% by volume or less. A cobalt content of the binder phase is 50% by mass or more. A 50% cumulative particle diameter D50 of the binder phase based on an area is 0.10 μm or more and 0.30 μm or less. A ratio D10/D90 of a 10% cumulative particle diameter D10 of the binder phase based on an area to a 90% cumulative particle diameter D90 of the binder phase based on an area is 0.26 or more and 0.40 or less. A vanadium content of the cemented carbide is 0.01% by mass or more and 0.20% by mass or less. A chromium content of the cemented carbide is 0.01% by mass or more and 1.00% by mass or less. The tungsten carbide particles include a first tungsten carbide particle having a crystal plane of {11-20} and a second tungsten carbide particle that exists adjacent to the crystal plane of {11-20}. In an interface region A between the crystal plane of {11-20} of the first tungsten carbide particle and the second tungsten carbide particle, a ratio A_{V}/A_{Co} of a maximum value A_{V} of the vanadium content to a maximum value A_{Co} of the cobalt content is 0.01 or more and 0.5 or less. In the interface region A, a ratio A_{Cr}/A_{Co} of a maximum value A_{Cr} of the chromium content to the maximum value A_{Co} of the cobalt content is 0.01 or more and 2.0 or less. The tungsten carbide particles include a third tungsten carbide particle having a crystal plane of {0001} and a fourth tungsten carbide particle that exists adjacent to the crystal plane of {0001}. In an interface region C between the crystal plane of {0001} of the third tungsten carbide particle and the fourth tungsten carbide particle, a ratio B_{V}/B_{Co} of a maximum value B_{V} of the vanadium content to a maximum value B_{Co} of the cobalt content is 0.01 or more and 1.2 or less. In the interface region C, a ratio B_{Cr}/B_{Co} of a maximum value B_{Cr} of the chromium content to the maximum value B_{Co} of the cobalt content is 0.01 or more and 2.0 or less.

### <Composition of Cemented Carbide>

The cemented carbide of Embodiment 1 includes a first hard phase consisting of tungsten carbide particles and a binder phase containing cobalt. The total content of the first hard phase and the binder phase of the cemented carbide is 80.0% by volume or more, may be 81.3% by volume or more and 100% by volume or less, may be 92% by volume or more and 100% by volume or less, may be 90% by volume or more and 99% by volume or less, may be 92% by volume or more and 98% by volume or less, or may be 94% by volume or more and 97% by volume or less.

The content of the binder phase of the cemented carbide of Embodiment 1 is 5.0% by volume or more and 21.0% by volume or less, may be 7% by volume or more and 20% by volume or less, or may be 10% by volume or more and 18% by volume or less.

The cemented carbide of Embodiment 1 may comprise a second hard phase in addition to the first hard phase and the binder phase. The second hard phase consists of at least one first compound selected from the group consisting of TiNbC, TiNbN, and TiNbCN. The content of the second hard phase of the cemented carbide may be more than 0% by volume and 20% by volume or less, may be more than 0% by volume and 18.7% by volume or less, may be more than 0% by volume and 10% by volume or less, or may be 1% by volume or more and 5% by volume or less.

The cemented carbide of Embodiment 1 may consist of the first hard phase and the binder phase. Within the scope that does not impair the effect of the present disclosure, the cemented carbide of Embodiment 1 may consist of the first hard phase, the binder phase, and impurities. The cemented carbide of Embodiment 1 may consist of the first hard phase, the binder phase, and the second hard phase. Within the scope that does not impair the effect of the present disclosure, the cemented carbide of Embodiment 1 may consist of the first hard phase, the binder phase, the second hard phase, and impurities.

Examples of the above impurities include iron (Fe), calcium (Ca), silicon (Si), and sulfur(S). The content of the impurities of the cemented carbide is acceptable within the scope that does not impair the effect of the present disclosure. For example, the content of the impurities of the cemented carbide may be 0% by mass or more and less than 0.1% by mass. The content of the impurities of the cemented carbide is measured by ICP emission spectroscopy (Inductively Coupled Plasma Emission Spectroscopy). As the measurement device “ICPS-8100”(trademark) available from SHIMADZU CORPORATION can be used.

A method for measuring the content of the first hard phase, the content of the binder phase, and the content of the second hard phase of the cemented carbide is as follows.

(A1) An arbitrary position of the cemented carbide is cut out to expose a cross section. The cross section is mirror-finished using a cross-section polisher (available from JEOL Ltd.).

(B1) The mirror-finished surface of the cemented carbide is photographed with a scanning electron microscope (SEM) to obtain a backscattered electron image. The photographed region is set to the center of the cross section of the cemented carbide, that is, a position that does not include any portion whose properties are clearly different from the bulk portion, such as the vicinity of the surface of the cemented carbide (a position where the photographed region is entirely the bulk portion of the cemented carbide). The observation magnification is 5000 times. The measurement conditions are an acceleration voltage of 3 kV, a current value of 2 nA, and a working distance (WD) of 5 mm.

(C1) The backscattered electron image obtained in the above (B1) is imported into a computer and is binarized using image analysis software (OpenCV, SciPy). In the image after the binarization processing, the first region consisting of the first hard phase and the second region consisting of the binder phase and the second hard phase can be distinguished by shades of colors. For example, in the image after the binarization processing, the first hard phase is shown as black regions, and the binder phase and the second hard phase are shown as white regions.

(D1) The photographed region of (B1) above is analyzed using an energy dispersive X-ray spectrometer (SEM-EDX) attached to a scanning electron microscope (apparatus: Gemini 450 (trademark) available from Carl Zeiss) to obtain an elemental mapping image.

(E1) The image after the binarization processing obtained in the above (C1) and the elemental mapping image obtained in the above (D1) are overlapped, and each of the existing regions of the first hard phase, the binder phase, and the second hard phase are identified on the image after the binarization processing. The regions, which are shown in black on the image after the binarization processing, and where tungsten (W) and carbon (C) exist on the elemental mapping image, correspond to the existing regions of the first hard phase. The regions, which are shown in white on the image after the binarization processing, and where cobalt (Co) exists on the elemental mapping image, correspond to the existing regions of the binder phase. The regions, which are shown in white on the image after the binarization processing, and where titanium (Ti) or niobium (Nb) exists on the elemental mapping image, correspond to the existing regions of the second hard phase.

(F1) A rectangular measurement field of view of 24.9 μm×18.8 μm is set in the image after the binarization processing. Using the image analysis software, the respective area percentages of the first hard phase, the binder phase, and the second hard phase are measured, with the area of the entire measurement field of view being taken as the denominator.

(G1) The above measurement of (F1) is performed on five different measurement fields of view that are not overlapped with each other. In the present disclosure, the average of the area percentages of the first hard phase in the five measurement fields of view corresponds to the content (% by volume) of the first hard phase in the cemented carbide. The average of the area percentages of the binder phase in the five measurement fields of view corresponds to the content (% by volume) of the binder phase in the cemented carbide. The average of the area percentages of the second hard phase in the five measurement fields of view corresponds to the content (% by volume) of the second hard phase in the cemented carbide.

As long as the measurements are performed on the same sample, it has been confirmed that there is almost no variation in the measurement results even if the above measurements are performed multiple times by changing the selected location of the measurement field of view.

### <First Hard Phase>

### <<Composition of First Hard Phase>>

In the cemented carbide of Embodiment 1, the first hard phase consists of a plurality of tungsten carbide particles (hereinafter referred to as “WC particles”). The tungsten carbide particles include not only “pure WC particles (including WC that contains no impurity element and WC in which a content of an impurity element is less than the detection limit)” but also “WC particles containing an impurity therein as long as the effect of the present disclosure is not impaired.” Examples of the impurities include iron (Fe), molybdenum (Mo), and sulfur(S).

### <<Mode of Tungsten Carbide Particles Based on Area in Particle Size Distribution>>

In the cemented carbide of Embodiment 1, a mode of tungsten carbide particles based on an area in particle size distribution may be 0.2 μm or more and 0.8 μm or less, may be 0.21 μm or more and 0.75 μm or less, may be 0.3 μm or more and 0.7 μm or less, or may be 0.4 μm or more and 0.6 μm or less.

In the present disclosure, a method for measuring the mode of tungsten carbide particles in the cemented carbide based on an area in particle size distribution is as follows.

(A2) In the same manners as in the (A1) to (E1) of the method for measuring the content of the first hard phase, the content of the binder phase, and the content of the second hard phase of the above-mentioned cemented carbide, the existing regions of the first hard phase are identified in the image after the binarization processing.

(B2) Five images after the binarization processing, in which the existing regions of the first hard phase are identified, are provided, and a rectangular measurement field of view of 40.3 μm in length×30.2 μm in width is set in each image. Using image analysis software (ImageJ ver. 1.51J8), the outer edge of each tungsten carbide particle in the measurement field of view is identified, and the area of each tungsten carbide particle is measured.

(C2) Based on all tungsten carbide particles in the five measurement fields of view, the mode of tungsten carbide particles based on an area in particle size distribution is measured. In the present disclosure, the mode of tungsten carbide particles based on an area in particle size distribution measured above corresponds to the mode of tungsten carbide particles in the cemented carbide based on an area in particle size distribution.

As long as the same sample is measured, it has been confirmed that there is almost no variation in the measurement results even if the above measurement is performed multiple times by changing the selected location of the measurement field of view.

### <Binder Phase>

### <<Composition of Binder Phase>>

In the cemented carbide of Embodiment 1, the cobalt content of the binder phase is 50% by mass or more. This allows the cemented carbide to have excellent toughness. The cobalt content of the binder phase may be 80% by mass or more and 100% by mass or less, or may be 90% by mass or more and 100% by mass or less.

The method for measuring the content of cobalt of the binder phase is as follows. An elemental mapping image and an image after the binarization processing are obtained in the same manners as in (A1) to (E1) of the method for measuring the content of the first hard phase, the content of the binder phase, and the content of the second hard phase of the above-mentioned cemented carbide. The elemental mapping image and the image after binarization processing are overlapped to identify the existing regions of the binder phase in the elemental mapping image. A rectangular measurement field of view of 24.9 μm×18.8 μm is set in the elemental mapping image. The cobalt content is measured in the existing regions of the binder phase in the measurement field of view. The above measurement is performed in five different measurement fields of view that do not overlap each other. In the present disclosure, the average of the cobalt contents in the existing regions of the binder phase in the five measurement fields of view corresponds to the cobalt content of the binder phase.

As long as the same sample is measured, it has been confirmed that there is almost no variation in the measurement results even if the above measurement is performed multiple times by changing the selected location of the measurement field of view.

In the cemented carbide of Embodiment 1, the binder phase may further contain at least one first element selected from the group consisting of silicon, germanium, rhenium, and ruthenium. This improves the deformation resistance of the binder phase. The binder phase may consist of cobalt and the first element.

In the cemented carbide of Embodiment 1, the binder phase may contain, in addition to cobalt and the first element, at least one second element selected from the group consisting of iron, nickel, and chromium. The binder phase may consist of cobalt, the first element, and the second element.

### <<D50 and D10/D90 of Binder Phase>>

In the cemented carbide of Embodiment 1, the 50% cumulative particle diameter D50 of the binder phase based on an area (hereinafter also referred to as “D50 of binder phase”) is 0.10 μm or more and 0.30 μm or less, may be 0.11 μm or more and 0.28 μm or less, or may be 0.12 μm or more and 0.20 μm or less.

In the cemented carbide of Embodiment 1, a ratio D10/D90 of the 10% cumulative particle diameter D10 of the binder phase based on an area to the 90% cumulative particle diameter D90 of the binder phase based on an area (hereinafter also referred to as “D10/D90 of binder phase”) is 0.26 or more and 0.40 or less, may be 0.27 or more and 0.38 or less, or may be 0.30 or more and 0.35 or less. The above D50 and the D10/D90 can be appropriately combined.

In the present disclosure, a method for measuring the D50 of the binder phase and the D10/D90 of the binder phase in the cemented carbide is as follows.

(A3) The existing regions of the binder phase in the image after the binarization processing are identified in the same manners as in (A1) to (E1) of the method for measuring the content of the first hard phase, the content of the binder phase, and the content of the second hard phase of the above-mentioned cemented carbide.

(B3) Five images after the binarization processing, in which the existing regions of the binder phase are identified, are provided, and a rectangular measurement field of view of 40.3 μm in length×30.2 μm in width is set in each image. Using image analysis software (ImageJ ver. 1.51J8), the outer edge of each binder phase in the measurement field of view is identified, and the area of each binder phase is measured.

(C3) Based on all the binder phases in the five measurement fields of view, the D50 of the binder phase, and the ratio D10/D90 of the D10 of the binder phase to the D90 of the binder phase are measured. In the present disclosure, the D50 of the binder phase and the D10/D90 of the binder phase measured above correspond to the D50 of the binder phase and the D10/D90 of the binder phase in the cemented carbide, respectively.

As long as the same sample is measured, it has been confirmed that there is almost no variation in the measurement results even if the above measurement is performed multiple times by changing the selected location of the measurement field of view.

### <Second Hard Phase>

### <<Composition>

In Embodiment 1, the second hard phase consists of at least one first compound selected from the group consisting of TiNbC, TiNbN, and TiNbCN. In the present disclosure, each of TiNbC, TiNbN, and TiNbCN is not limited to a case where a ratio between the total number of atoms of Ti and Nb and the total number of atoms of C and Nis 1:1, and may include any conventionally known ratio as long as the effect of the present disclosure is not impaired.

The second hard phase may contain metal elements such as tungsten (W), chromium (Cr), and cobalt (Co) within the range that does not impair the effect of the present disclosure. The total content of W, Cr, and Co in the second hard phase may be 0% by mass or more and less than 0.1% by mass. The contents of W, Cr, and Co in the second hard phase are measured by STEM-EDX.

A method for measuring the composition of the second hard phase is as follows.

(A4) An arbitrary position of the cemented carbide is sliced using an ion slicer (apparatus: IB09060CIS (trademark) available from JEOL Ltd.) to prepare a sample having a thickness of 30 nm to 100 nm. The accelerating voltage of the ion slicer is 6 kV for the thinning process and 2 kV for the finishing process.

(B4) The above sample is observed at 50,000× magnification with a scanning transmission electron microscope (STEM) (JFM-ARM300F (trademark) available from JEOL Ltd.) to obtain a STEM-HAADF (HAADF: high-angle annular dark field) image. The photographed region of the STEM-HAADF image is set to the center of the sample, that is, a position that does not include any portion whose properties are clearly different from the bulk portion, such as the vicinity of the surface of the cemented carbide (a position where the photographed region is entirely the bulk portion of the cemented carbide). The measurement condition is an acceleration voltage of 200 kV.

(C4) Next, element mapping analysis is performed on the STEM-HAADF image using EDX attached to the STEM, and an elemental mapping image is obtained. In the elemental mapping image, the region where titanium (Ti) and niobium (Nb) and one or both of carbon (C) and nitrogen (N) are present is identified as the second hard phase, and the composition of the second hard phase is identified.

As long as the same sample is measured, it has been confirmed that there is almost no variation in the measurement results even if the above measurement is performed multiple times by changing the selected location of the measurement field of view.

### <<50% Cumulative Particle Diameter D50 of Second Hard Phase Based on Area>>

In the cross section of the cemented carbide of Embodiment 1, the 50% cumulative particle diameter D50 of the second hard phase based on an area may be 0.003 μm or more and 0.05 μm or less, or may be 0.008 μm or more and 0.02 μm or less.

In the present disclosure, the 50% cumulative particle diameter D50 of the second hard phase of the cemented carbide based on an area (hereinafter also referred to as “D50 of the second hard phase”) is measured in the same manner as in the method for measuring the D50 of the binder phase of the above cemented carbide except that the existing regions of the second hard phase instead of the binder phase are identified in the image after the binarization processing. As long as the same sample is measured, it has been confirmed that there is almost no variation in the measurement results even if the above measurement is performed multiple times by changing the selected location of the measurement field of view.

### <Vanadium Content>

The vanadium content of the cemented carbide of Embodiment 1 is 0.01% by mass or more and 0.20% by mass or less, may be 0.02% by mass or more and 0.19% by mass or less, or may be 0.05% by mass or more and 0.15% by mass or less. The content of vanadium of the cemented carbide is measured by ICP emission spectral analysis.

### <Chromium Content>

The chromium content of the cemented carbide of Embodiment 1 is 0.01% by mass or more and 1.00% by mass or less, may be 0.02% by mass or more and 0.99% by mass or less, or may be 0.05% by mass or more and 0.95% by mass or less. The chromium content of the cemented carbide is measured by ICP emission spectral analysis.

<A_{V}/A_{Co} and A_{Cr}/A_{Co} in Interface Region A>

The tungsten carbide particles of the cemented carbide of Embodiment 1 include a first tungsten carbide particle having a crystal plane of {11-20} and a second tungsten carbide particle that exists adjacent to the crystal plane of {11-20}. In the interface region A between the crystal plane of {11-20} of the first tungsten carbide particle and the second tungsten carbide particle, a ratio A_{V}/A_{Co} of the maximum value A_{V} of the vanadium content to the maximum value A_{Co} of the cobalt content is 0.01 or more and 0.5 or less, may be 0.01 or more and 0.45 or less, may be 0.01 or more and 0.3 or less, or may be 0.01 or more and 0.2 or less.

In the interface region A, a ratio A_{Cr}/A_{Co} of the maximum value A_{Cr} of the chromium content to the maximum value A_{Co} of the cobalt content is 0.01 or more and 2.0 or less, may be 0.01 or more and 1.7 or less, may be 0.01 or more and 1.5 or less, or may be 0.01 or more and 0.9 or less. The above A_{V}/A_{Co} and A_{Cr}/A_{Co} can be appropriately combined.

A method for measuring the A_{V}/A_{Co} and the A_{Cr}/A_{Co} in the interface region A is as follows.

(A5) Using an ion slicer or the like, a thin sample having a thickness of 50 nm or less is cut out from a cemented carbide. The surface of the thin sample is mirror-finished. Examples of the mirror-finishing method include a polishing method that uses diamond paste, a method that uses a focused ion beam device (FIB device), a method that uses a cross-section polisher device (CP device), and combinations thereof.

(B5) The mirror-finished surface of the thin sample is observed with a scanning transmission electron microscope (STEM) (JFM-ARM300F (trademark) available from JEOL Ltd.) to obtain an electron diffraction image of a WC particle. The observation magnification is 2 million times, and the pixel is 256×256.

(C5) In the electron diffraction image, the crystal plane of {11-20} of the WC particle is identified. While the first WC particle having an identified crystal plane of {11-20} is observed from the orientation of {11-20}, the second WC particle that exists adjacent to the crystal plane of {11-20} of the first WC particle is identified.

The crystal plane of the second WC particle adjacent to the crystal plane of {11-20} of the first WC particle is not particularly limited as long as it is a crystal plane of a WC particle, and may be, for example, a plane of {01-12}, a plane of {0001}, a plane of {11-20}, or a plane of {10-10}.

Line analysis is performed on the interface region A between the crystal plane of {11-20} of the first WC particle and the second WC particle using EDX (energy dispersive X-ray spectroscopy) attached to a TEM. In the line analysis, each of the percentages of W, Co, Cr, and V is measured when the total number of atoms of tungsten (W), cobalt (Co), chromium (Cr) and vanadium (V) is 100 atomic %.

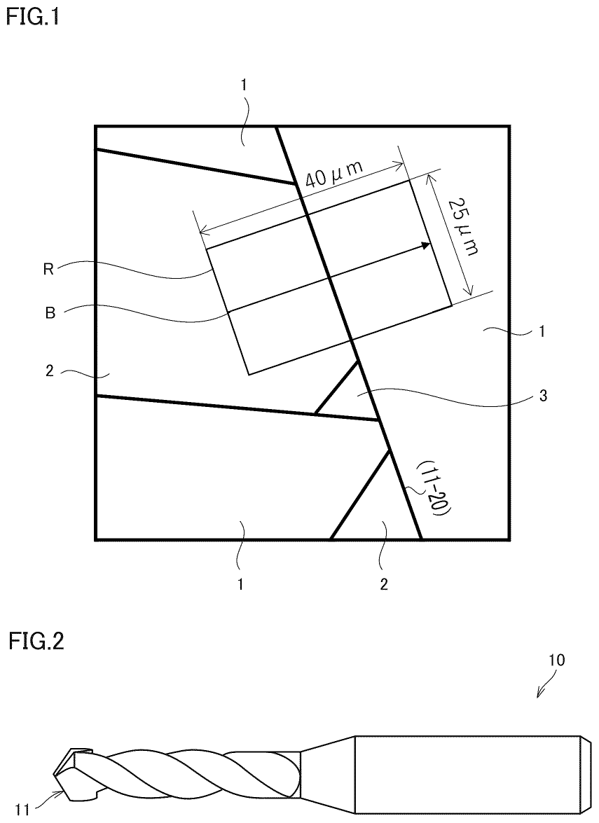

The specific procedure of the line analysis is explained using FIG. 1. FIG. 1 schematically shows an electron diffraction image obtained by observing a thin sample with a TEM. In FIG. 1, a measurement region R of the line analysis is the rectangular region indicated by the symbol R.

As shown in FIG. 1, an approximately straight portion, which is approximately straight and has a length of 25 nm or more, is selected from an interface between a crystal plane of {11-20} of a first WC particle 1 and a second WC particle 2 existing adjacent to the crystal plane of {11-20} of the first WC particle 1. Line analysis is performed in a direction perpendicular to the approximately straight portion (a direction indicated by an arrow B in FIG. 1). The distance of the line analysis is 20 nm on both the side of first WC particle 1 and the side of second WC particle 2, centering around the approximately straight portion. The width of the line analysis is 25 nm, and the step interval is 0.4 nm. As shown in FIG. 1, measurement region R of the line analysis is set so that a binder phase 3 is not included.

Based on the line analysis results, the maximum value A_{Co} of the cobalt content, the maximum value A_{V} of the vanadium content, and the maximum value A_{Cr} of the chromium content within measurement region R are identified, and the A_{V}/A_{Co} and the A_{Cr}/A_{Co} are calculated.

(D5) The measurement of the above (C5) is performed in the interface region A between the crystal plane of {11-20} of five different first WC particles and the second WC particle. The average value of A_{V}/A_{Co} in the five interface regions A is calculated. This average value corresponds to the A_{V}/A_{Co} in the interface region A of the cemented carbide of the present disclosure. The average value of A_{Cr}/A_{Co} in the five interface regions is calculated. This average value corresponds to the A_{Cr}/A_{Co} in the interface region A of the cemented carbide of the present disclosure.

As long as the same sample is measured, it has been confirmed that there is almost no variation in the measurement results even if the above measurement is performed multiple times by changing the selected location of the measurement region and the interface region of the measured target.

<B_{V}/B_{Co} and B_{Cr}/B_{Co} in Interface Region C>

The tungsten carbide particles of the cemented carbide of Embodiment 1 include a third tungsten carbide particle having a crystal plane of {0001} and a fourth tungsten carbide particle that exists adjacent to the crystal plane of {0001}. In the interface region C between the crystal plane of {0001} of the third tungsten carbide particle and the fourth tungsten carbide particle, a ratio B_{V}/B_{Co} of the maximum value B_{V} of the vanadium content to the maximum value B_{Co} of the cobalt content is 0.01 or more and 1.2 or less, may be 0.35 or more and 1.2 or less, may be 0.4 or more and 1.2 or less, or may be 0.4 or more and 1.1 or less.

In the interface region C, a ratio B_{Cr}/B_{Co} of the maximum value B_{Cr} of the chromium content to the maximum value B_{Co} of the cobalt content is 0.01 or more and 2.0 or less, may be 0.5 or more and 2.0 or less, may be 0.5 or more and 1.98 or less, or may be 1.32 or more and 1.98 or less. The above B_{V}/B_{Co} and B_{Cr}/B_{Co} can be appropriately combined.

A method for measuring the By/B_{Co} and the B_{Cr}/B_{Co} in the interface region C is as follows. An electron diffraction image of a WC particle is obtained in the same manners as in (A5) and (B5) of the method for measuring the A_{V}/A_{Co} and the A_{Cr}/A_{Co} in the interface region A described above. In the electron diffraction image, the crystal plane of {0001} of the WC particle is identified. While it is observed from the orientation of {0001}, the crystal plane of {0001} of the third WC particle and the fourth WC particle that exists adjacent to the crystal plane of {0001} of the third WC particle are identified.

The crystal plane of the fourth WC particle adjacent to the crystal plane of {0001} of the third WC particle is not particularly limited as long as it is a crystal plane of a WC particle, and may be, for example, a plane of {01-12}, a plane of {11-20}, a plane of {0001}, or a plane of {10-10}.

Line analysis is performed on the interface region C between the crystal plane of {0001} of the third WC particle and the fourth WC particle by EDX attached to TEM. The specific procedure of the line analysis is as follows. With reference to (C5) of the method for measuring A_{V}/A_{Co} and A_{Cr}/A_{Co} in the interface region A, the crystal plane of {0001} of the WC particle is identified in the electron diffraction image. While the third WC particle having an identified crystal plane of {0001} is observed from the orientation of {0001}, the fourth WC particle that exists adjacent to the crystal plane of {0001} of the third WC particle is identified. An approximately straight portion, which is approximately straight and has a length of 25 nm or more, is selected from an interface between a crystal plane of {0001} of a third WC particle and a fourth WC particle within measurement region R. Line analysis is performed in a direction perpendicular to the approximately straight portion.

Based on the line analysis results, the maximum value B_{Co} of the cobalt content, the maximum value By of the vanadium content, and the maximum value B_{Cr} of the chromium content within measurement region R are identified, and the By/B_{Co} and the B_{Cr}/B_{Co} are calculated.

The above measurement is performed in the interface region C between the crystal plane of {0001} of five different third WC particles and the fourth WC particle. The average value of B_{V}/B_{Co} in the five interface regions C is calculated. This average value corresponds to the B_{V}/B_{Co} in the interface region C of the cemented carbide of the present disclosure. The average value of B_{Cr}/B_{Co} in the five interface regions is calculated. This average value corresponds to the B_{Cr}/B_{Co} in the interface region C of the cemented carbide of the present disclosure.

As long as the same sample is measured, it has been confirmed that there is almost no variation in the measurement results even if the above measurement is performed multiple times by changing the selected location of the measurement region and the interface region of the measured target.

### <Method for Producing Cemented Carbide>

The cemented carbide of Embodiment 1 can be produced by performing a providing step of raw material powder, a mixing step, a compacting step, a sintering step, and a HIP (Hot Isostatic Pressing) step in the above order. Each step will be described below.

### <Providing Step>

The providing step is a step of providing raw material powder of a material that constitutes the cemented carbide. Examples of the raw material powder include tungsten carbide powder containing a grain growth inhibitor containing chromium (Cr), vanadium (V), or the like (hereinafter also referred to as “WC powder containing grain growth inhibitor”), Co powder, VC powder, and Cr₃C₂ powder. The average particle diameter of the WC powder containing grain growth inhibitor is 0.2 μm.

The average particle diameter of the Co powder is 0.5 μm. The Co powder is strongly pulverized using Atritor to prepare a Co slurry. The Atritor conditions are a rotation speed of 200 rpm for 2 hours.

The WC powder containing grain growth inhibitor is added to the Co slurry, and the mixture is strongly pulverized using a bead mill to obtain a first mixture.

As the VC powder and the Cr₃C₂ powder, commercially available products can be used. The average particle diameters of these raw material powders are not particularly limited, and may be, for example, 0.5 μm to 2 μm.

Furthermore, TiC powder, TiN powder, NbC powder, Ni powder, and the like can be provided as raw material powders. As these raw material powders, commercially available products can be used. The average particle diameters of these raw material powders are not particularly limited, and may be, for example, 0.5 μm to 2 μm.

The average particle diameter of the raw material powder means an average particle diameter measured by the FSSS (Fisher Sub-Sieve Sizer) method. The average particle diameter is measured using “Sub-Sieve Sizer Model 95”(trademark) available from Fisher Scientific.

### <Mixing Step>

The mixing step is a step of mixing the raw material powders (including the first mixture) provided in the providing step in a predetermined proportion to obtain a mixed powder. The mixing proportion of each raw material powder is appropriately adjusted according to the composition of the cemented carbide to be targeted.

A bead mill is used to mix the raw material powders. The mixing conditions are a rotation speed of 3000 rpm, a ball diameter of $1 mm, and a mixing time of 6 hours.

After the mixing step, the mixed powder may be granulated if necessary. Granulating the mixed powder makes it easier to fill the mixed powder into a die or mold during the compacting step described below. A known granulation method can be applied to granulation, and, for example, a commercially available granulator such as a spray dryer can be used.

### <Compacting Step>

The compacting step is a step of compacting the mixed powder obtained in the mixing step into a predetermined shape for a cutting tool to obtain a compact. As the compacting method and the compacting conditions in the compacting step, a general method and general conditions may be adopted and are not particularly limited.

### <Sintering Step>

The sintering step is a step of sintering the compact obtained in the compacting step to obtain a cemented carbide intermediate. The compact is placed in an S-HIP apparatus, heated to 1350° C. at a temperature increasing rate of 20° C./min under an argon atmosphere and a pressure of 7 MPa, and maintained at 1350° C. for 4 hours. The compact is then cooled to 25° C. at a temperature decreasing rate of −50° C./min to obtain a cemented carbide intermediate.

### <HIP Step>

In the HIP step, HIP is performed on the cemented carbide intermediate. The HIP is performed under the conditions of an Ar atmosphere, 10 MPa, and maintaining at 1300° C. for 2 hours. Then, cooling is performed to obtain the cemented carbide of Embodiment 1. Conventional known conditions can be used for the cooling conditions.

### <Characteristics of Method for Producing Cemented Carbide of Embodiment 1>

In the method for producing the cemented carbide of Embodiment 1, a WC powder containing grain growth inhibitor is used. This improves the dispersibility of the VC powder in the mixed powder, and suppresses the formation of a vanadium concentrated layer in the cemented carbide structure. In the conventional method for producing a general cemented carbide, a WC powder containing grain growth inhibitor is not used, and therefore the formation of the vanadium concentrated layer is insufficiently suppressed.

In the method for producing the cemented carbide of Embodiment 1, a fine Co slurry, which is obtained by strongly pulverizing, with Atritor, fine Co powder having an average particle diameter of 0.5 μm for slurry, is used. Furthermore, a WC powder containing grain growth inhibitor is added to the Co slurry, which is strongly pulverized with a bead mill, to thereby obtain a first mixture. As a result, fine cobalt is uniformly dispersed in the cemented carbide without being locally aggregated, and the cemented carbide structure is easily homogenous. In the conventional method for producing a general cemented carbide, the above-mentioned step of performing a fining treatment on the fine Co powder having an average particle diameter of 0.5 μm is not performed, and therefore the uniform dispersion of cobalt in the cemented carbide is insufficient.

In the mixing step of the method for producing the cemented carbide of Embodiment 1, the raw material powder is mixed at a high speed using an ultrafine ball. This facilitates fining of the raw material powder, improves the dispersibility of the raw materials in the cemented carbide, and easily makes the cemented carbide structure homogenous. In the conventional method for producing a general cemented carbide, high speed mixing using an ultrafine ball is not performed, and therefore fining the raw material powder is insufficient.

In the sintering step of the method for producing the cemented carbide of Embodiment 1, the compact is placed in an S-HIP apparatus, heated to 1350° C. at a temperature increasing rate of 20° C./min under an argon atmosphere and a pressure of 7 MPa, and maintained at 1350° C. for 4 hours. This allows the cemented carbide structure to be densified even at low temperatures, improves the dispersibility of the raw materials in the cemented carbide, and easily makes the cemented carbide structure homogenous. In the conventional method for producing a general cemented carbide, S-HIP is not performed at low temperatures, and the cemented carbide structure is insufficiently densified and homogenized.

In the sintering step of the method for producing the cemented carbide of Embodiment 1, the compact is cooled from 1350° C. to 25° C. at a temperature decreasing rate of −50° C./min. This makes it possible to suppress reprecipitation of V and Cr dissolved in Co, and to suppress the formation of a vanadium concentrated layer and a chromium concentrated layer. In the conventional method for producing a general cemented carbide, rapid cooling at a temperature decreasing rate of −50° C./min is not performed, and therefore the formation of the vanadium concentrated layer and the chromium concentrated layer is insufficiently suppressed.

In the HIP step of the method for producing the cemented carbide of Embodiment 1, low-temperature HIP is performed. This densifies the cemented carbide structure and suppresses the grain growth of WC. In the conventional method for producing a general cemented carbide, HIP is often not performed from the viewpoint of cost reduction. Alternatively, even if HIP is performed, it is performed at a high temperature (e.g., 1350° C.), and thus densification of the cemented carbide and suppression of grain growth of WC are insufficient.

As a result of extensive researches, the present inventors have found that the above-mentioned production steps can be adopted to achieve the cemented carbide of the present disclosure.

### Embodiment 2: Cutting Tool

A cutting tool of one embodiment of the present disclosure (hereinafter also referred to as “Embodiment 2”) includes a cutting edge consisting of the cemented carbide of Embodiment 1. In the present disclosure, the cutting edge means a portion involved in cutting. More specifically, the cutting edge means a region surrounded by a cutting edge ridgeline thereof and a virtual plane at a distance of 0.5 mm or 2 mm from the cutting edge ridgeline toward the cemented carbide side.

Examples of the cutting tool can include a cutting bit, a drill, an end mill, an indexable cutting insert for milling working, an indexable cutting insert for turning working, a metal saw, a gear cutting tool, a reamer, and a tap. In particular, as shown in FIG. 1, a cutting tool 10 of Embodiment 2 can exhibit an excellent effect in the case of an end mill. A cutting edge 11 of cutting tool 10 shown in FIG. 1 consists of the cemented carbide of Embodiment 1.

The cemented carbide of Embodiment 1 in the cutting tool of Embodiment 2 may constitute the whole of each of these tools, or may constitute a part thereof. Here, the term “constitute a part” refers to, for example, an aspect in which a cutting edge portion is formed by brazing the cemented carbide of Embodiment 1 at a predetermined position of an arbitrary base material.

The cutting tool of Embodiment 2 may further include a hard film that coats at least a part of the surface of a base material consisting of the cemented carbide. For example, diamond-like carbon or diamond can be used as the hard film.

The cutting tool of Embodiment 2 can be obtained by compacting the cemented carbide of Embodiment 1 to a desired shape.

### Examples

The present embodiment will be described more specifically with reference to Examples. However, the present embodiment is not limited by these Examples.

### [Production of Cemented Carbide]

### <<Sample 1 to Sample 16 and Sample 101 to Sample 110>>

The cemented carbides of Sample 1 to Sample 16 and Sample 101 to Sample 110 were produced in the following steps.

### <Providing Step>

As raw material powders, WC powder containing grain growth inhibitor (“WC02NP” available from A.L.M.T. Corp., average particle diameter of 0.2 μm, described as “WC containing grain growth inhibitor” in Table 1), WC powder (average particle diameter of 0.2 μm, without addition of V, described as “WC” in Table 1), Co powder (average particle diameter of 0.5 μm or 2.5 μm), VC powder, Cr₃C₂ powder, TiC powder, TiN powder, NbC powder, Ni powder, Si powder, Ge powder, Re powder, and Ru powder were provided in the proportions described in Table 1. The average particle diameters of the raw material powders other than the WC powder containing grain growth inhibitor and the Co powder are 1 μm. The proportions (% by mass) of the respective raw material powders shown in Table 1 are the proportions when the entire raw material powder is considered as 100% by mass. The “balance” in Table 1 indicates that the proportion of the WC powder containing grain growth inhibitor or the WC powder is the value obtained by subtracting the total proportion of other raw material powders from 100% by mass of the entire raw material powders.

Co powder (average particle diameter of 0.5 μm or 2.5 μm) was strongly pulverized with Atritor to produce a fine Co slurry. The conditions of Atritor were a rotation speed of 200 rpm for 2 hours.

TABLE 1

| | Raw material powder (% by mass) | | | | | | | | | | |
|---|---|---|---|---|---|---|---|---|---|---|---|
| | WC | | | | | | | | | | |
| | containing | | Co | Co | | | | | | | |
| | grain | | Particle | Particle | | | | | | Others | |
| Sample | growth | | diameter | diameter | | | | | | Compo- | % by |
| No. | inhibitor | WC | 0.5 μm | 2.5 μm | VC | Cr₃C₂ | TiC | TiN | NbC | sition | mass |
| 1 | Balance | 0 | 4.48 | 0 | 0.02 | 0.82 | 0 | 0 | 0 | — | — |
| 2 | Balance | 0 | 14.07 | 0 | 0.04 | 0.82 | 0.1 | 0 | 0.1 | — | — |
| 3 | Balance | 0 | 8.40 | 0 | 0.05 | 0.82 | 0 | 10.0 | 0.1 | — | — |
| 4 | Balance | 0 | 8.40 | 0 | 0.00 | 0.82 | 0 | 0.3 | 0.1 | — | — |
| 5 | Balance | 0 | 8.40 | 0 | 0.02 | 0.82 | 0 | 0.2 | 0.2 | — | — |
| 6 | Balance | 0 | 4.45 | 0 | 0.02 | 0.82 | 0 | 0 | 0 | Ni | 3.95 |
| 7 | Balance | 0 | 8.40 | 0 | 0.02 | 0.82 | 0 | 0 | 0 | — | — |
| 8 | Balance | 0 | 8.40 | 0 | 0.02 | 0.82 | 0 | 0 | 0 | Si | 0.1 |
| 9 | Balance | 0 | 8.40 | 0 | 0.02 | 0.82 | 0 | 0 | 0 | Ge | 0.1 |
| 10 | Balance | 0 | 8.40 | 0 | 0.02 | 0.82 | 0 | 0 | 0 | Re | 0.1 |
| 11 | Balance | 0 | 8.40 | 0 | 0.02 | 0.82 | 0 | 0 | 0 | Ru | 0.1 |
| 12 | Balance | 0 | 8.40 | 0 | 0.02 | 0.82 | 0 | 0 | 0 | — | — |
| 13 | Balance | 0 | 8.40 | 0 | 0.02 | 0.82 | 0 | 0 | 0 | — | — |
| 14 | Balance | 0 | 8.40 | 0 | 0.02 | 0.82 | 0 | 0 | 0 | — | — |
| 15 | Balance | 0 | 8.40 | 0 | 0.02 | 0.02 | 0 | 0 | 0 | — | — |
| 16 | Balance | 0 | 8.40 | 0 | 0.02 | 1.16 | 0 | 0 | 0 | — | — |
| 101 | 0 | Balance | 20.00 | 0 | 0.12 | 0.82 | 0 | 0 | 0 | — | — |
| 102 | 0 | Balance | 3.00 | 0 | 0.12 | 0.82 | 0 | 0 | 0 | — | — |
| 103 | 0 | Balance | 8.50 | 0 | 0.12 | 0.82 | 0.1 | 8.5 | 0.1 | — | — |
| 104 | 0 | Balance | 8.50 | 0 | 0.00 | 0.82 | 0 | 0.1 | 0.1 | — | — |
| 105 | Balance | 0 | 8.50 | 0 | 0.12 | 0.82 | 0 | 0.1 | 0.1 | — | — |
| 106 | 0 | Balance | 8.50 | 0 | 0.26 | 0.82 | 0 | 0.3 | 0.1 | — | — |
| 107 | 0 | Balance | 3.50 | 0 | 0.12 | 0.82 | 0 | 0.2 | 0.2 | Ni | 5.0 |
| 108 | 0 | Balance | 8.50 | 0 | 0.12 | 0.82 | 0 | 0 | 0 | — | — |
| 109 | 0 | Balance | 0 | 8.5 | 0.12 | 0.82 | 0 | 0 | 0 | — | — |
| 110 | 0 | Balance | 8.50 | 0 | 0.23 | 1.41 | 0 | 0 | 0 | — | — |
| 111 | 0 | Balance | 10.00 | 0 | 0.24 | 0.46 | 0 | 0 | 0 | — | — |
| 112 | 0 | Balance | 10.00 | 0 | 0.50 | — | 0 | 0 | 0 | — | — |

### <Mixing Step>

In the mixing step, each raw material powder was mixed under the following conditions of A or B. The conditions used for each sample are shown in Table 2. The conditions of B are the conventional general mixing conditions.

A: A bead mill is used. The mixing conditions are a rotation speed of 3000 rpm, a ball diameter of φ1 mm, and mixing time of 6 hours.

B: Atritor is used. The mixing conditions are a rotation speed of 100 rpm, a ball diameter of φ 6 mm, and mixing time of 6 hours.

### <Compacting Step>

The mixed powder was pressed to obtain a round bar-shaped compact.

### <Sintering Step>

The compact was placed in an S-HIP apparatus and heated to the temperature described in the “temperature” column of Table 2 at a temperature increasing rate of 20° C./min under the conditions described in the “Atmosphere/pressure” column of “Sintering” in Table 2 (“vac” means vacuum, and “Ar/7 MPa” means an argon atmosphere and a pressure of 7 MPa), and then maintained at that temperature for the time described in the “Time” column. The compact was then cooled to 25° C. at the temperature decreasing rate described in the “Temperature decreasing rate” column of Table 2 to obtain a cemented carbide intermediate.

TABLE 2

| | | Sintering | | | | |
|---|---|---|---|---|---|---|
| | | | | | Temperature | |
| Sample | | Atmosphere/ | Temperature | Time | decreasing rate | |
| No. | Mixing | pressure | ° C. | hr | ° C./min | |
| 1 | A | Ar/7 MPa | 1350 | 4.0 | −50° | C. |
| 2 | A | Ar/7 MPa | 1350 | 4.0 | −50° | C. |
| 3 | A | Ar/7 MPa | 1350 | 4.0 | −50° | C. |
| 4 | A | Ar/7 MPa | 1350 | 4.0 | −50° | C. |
| 5 | A | Ar/7 MPa | 1350 | 4.0 | −50° | C. |
| 6 | A | Ar/7 MPa | 1350 | 4.0 | −50° | C. |
| 7 | A | Ar/7 MPa | 1350 | 4.0 | −50° | C. |
| 8 | A | Ar/7 MPa | 1350 | 4.0 | −50° | C. |
| 9 | A | Ar/7 MPa | 1350 | 4.0 | −50° | C. |
| 10 | A | Ar/7 MPa | 1350 | 4.0 | −50° | C. |
| 11 | A | Ar/7 MPa | 1350 | 4.0 | −50° | C. |
| 12 | A | Ar/7 MPa | 1350 | 4.0 | −50° | C. |
| 13 | A | Ar/7 MPa | 1350 | 4.0 | −50° | C. |
| 14 | A | Ar/7 MPa | 1350 | 4.0 | −50° | C. |
| 15 | A | Ar/7 MPa | 1350 | 4.0 | −50° | C. |
| 16 | A | Ar/7 MPa | 1350 | 4.0 | −50° | C. |
| 101 | A | Ar/7 MPa | 1400 | 4.0 | −50° | C. |
| 102 | A | Ar/7 MPa | 1400 | 4.0 | −50° | C. |
| 103 | A | Ar/7 MPa | 1400 | 4.0 | −50° | C. |
| 104 | A | Ar/7 MPa | 1400 | 4.0 | −50° | C. |
| 105 | B | vac | 1400 | 4.0 | −50° | C. |
| 106 | A | Ar/7 MPa | 1400 | 4.0 | −50° | C. |
| 107 | A | Ar/7 MPa | 1400 | 4.0 | −50° | C. |
| 108 | B | vac | 1400 | 4.0 | −50° | C. |
| 109 | A | Ar/7 MPa | 1400 | 4.0 | −50° | C. |
| 110 | A | Ar/7 MPa | 1400 | 4.0 | −50° | C. |
| 111 | Ball mill | Ar/7 MPa | 1420 | 1.0 | Repeated heat | |
| | | | | | treatment | |
| 112 | Ball mill | vac | 1380 | 1.5 | −0.67° | C. |

### <HIP Step>

The cemented carbide intermediate was subjected to HIP under the conditions described in the “HIP” column of Table 3. It was then cooled to obtain a cemented carbide.

TABLE 3

HIP

| | Atmosphere/ | Temperature | Time |
|---|---|---|---|
| Sample No. | pressure | ° C. | hr |
| 1 | Ar/10 MPa | 1300 | 2 |
| 2 | Ar/10 MPa | 1300 | 2 |
| 3 | Ar/10 MPa | 1300 | 2 |
| 4 | Ar/10 MPa | 1300 | 2 |
| 5 | Ar/10 MPa | 1300 | 2 |
| 6 | Ar/10 MPa | 1300 | 2 |
| 7 | Ar/10 MPa | 1300 | 2 |
| 8 | Ar/10 MPa | 1300 | 2 |
| 9 | Ar/10 MPa | 1300 | 2 |
| 10 | Ar/10 MPa | 1300 | 2 |
| 11 | Ar/10 MPa | 1300 | 2 |
| 12 | Ar/10 MPa | 1300 | 2 |
| 13 | Ar/10 MPa | 1300 | 2 |
| 14 | Ar/10 MPa | 1300 | 2 |
| 15 | Ar/10 MPa | 1300 | 2 |
| 16 | Ar/10 MPa | 1300 | 2 |
| 101 | Ar/10 MPa | 1350 | 2 |
| 102 | Ar/10 MPa | 1350 | 2 |
| 103 | Ar/10 MPa | 1350 | 2 |
| 104 | Ar/10 MPa | 1350 | 2 |
| 105 | Ar/10 MPa | 1350 | 2 |
| 106 | Ar/10 MPa | 1350 | 2 |
| 107 | Ar/10 MPa | 1350 | 2 |
| 108 | Ar/10 MPa | 1350 | 2 |
| 109 | Ar/10 MPa | 1350 | 2 |
| 110 | Ar/10 MPa | 1350 | 2 |
| 111 | — | — | — |
| 112 | — | — | — |

### <Sample 111>

The cemented carbide of Sample 111 was produced by the following steps based on the production method of PTL 1.

### <Providing Step>

As raw material powders, powders with the composition described in the “Mixed powder” column of Table 1 were provided.

The respective raw material powders were mixed in the amounts blended shown in the “% by mass” of “Mixed powder” in Table 1 to produce a mixed powder. Mixing was performed with a ball mill for 15 hours.

### <Compacting Step>

The mixed powder was pressed to obtain a round bar-shaped compact.

### <Sintering Step>

A preliminary sintering step was performed on the compact. In the preliminary sintering step, the compact was placed in a sintering furnace and maintained under vacuum at 100° C. for 2 hours (preliminary sintering). Then, the main sintering step was performed. The compact obtained after the preliminary sintering step was maintained under an Ar atmosphere at 1420 for 1 hour to obtain a cemented carbide.

### <Repeated Heat Treatment Step>

Then, the cemented carbide obtained in the sintering step was subjected to a rapid cooling step and a heat treatment step, each of which was alternately performed twice. In the rapid cooling step, the cemented carbide was rapidly cooled to 1100° C. at a cooling rate of −60° C./min or more, and maintained at 1100° C. for 30 minutes. In the heat treatment step, the cemented carbide was heated to 1250° C., and maintained at 1250° C. for 20 minutes.

### <Cooling Step>

Then, the cemented carbide obtained after the repeated heat treatment step was slowly cooled in an argon (Ar) gas atmosphere to obtain the cemented carbide of Sample 111.

### <<Sample 112>>

The cemented carbide of Sample 112 was produced in the following steps based on the production method of Cited Reference 1 (Masaru Kawakami, Osamu Terada and Koji Hayashi, Effect of Sintering Cooling Rate on V Segregation Amount at WC/Co Interface in VC-doped WC—Co Fine-Grained Hardmetal, J. Jpn. Soc. Powder Powder Metallurgy, Vol. 51, No. 8, 2004, p 576-585).

### <Providing Step>

As raw material powders, powders with the composition described in the “Mixed powder” column of Table 1 were provided.

The respective raw material powders were mixed in the amounts blended shown in the “% by mass” of “Mixed powder” in Table 1 to produce a mixed powder. Mixing was performed with a ball mill at 432 ks.

### <Compacting Step>

The mixed powder was pressed to obtain a round bar-shaped compact.

### <Sintering Step>

The compact was maintained at 1380° C. for 1.5 hours in vacuum, and then cooled at −0.67° C./s to obtain a cemented carbide.

### [Evaluation of Cemented Carbide]

### <Content of First Hard Phase, Content of Binder Phase, Content of Second Hard Phase, Vanadium Content, and Chromium Content of Cemented Carbide>

The content of the first hard phase (% by volume), the content of the binder phase (% by volume), the content of the second hard phase (% by volume), the vanadium content (% by mass), and the chromium content (% by mass) of the cemented carbide of each sample were measured by the method described in Embodiment 1. The results are shown in Table 4.

TABLE 4

| | Cemented carbide | | | | | |
|---|---|---|---|---|---|---|
| | First | | Second | | | |
| | hard | Binder | hard | First hard | | |
| | phase | phase | phase | phase + binder | V | Cr |
| Sample | % by | % by | % by | phase | % by | % by |
| No. | volume | volume | volume | % by volume | mass | mass |
| 1 | 94.6 | 5.4 | 0 | 100 | 0.10 | 0.70 |
| 2 | 78.9 | 20.1 | 1.0 | 99.0 | 0.12 | 0.70 |
| 3 | 69.3 | 12.0 | 18.7 | 81.3 | 0.13 | 0.70 |
| 4 | 87.0 | 12.0 | 1.0 | 99.0 | 0.02 | 0.70 |
| 5 | 87.0 | 12.0 | 1.0 | 99.0 | 0.19 | 0.70 |
| 6 | 88.0 | 12.0 | 0 | 100 | 0.10 | 0.70 |
| 7 | 88.0 | 12.0 | 0 | 100 | 0.10 | 0.70 |
| 8 | 87.8 | 12.2 | 0 | 100 | 0.10 | 0.70 |
| 9 | 87.8 | 12.2 | 0 | 100 | 0.10 | 0.70 |
| 10 | 87.8 | 12.2 | 0 | 100 | 0.10 | 0.70 |
| 11 | 87.8 | 12.2 | 0 | 100 | 0.10 | 0.70 |
| 12 | 88.0 | 12.0 | 0 | 100 | 0.10 | 0.70 |
| 13 | 88.0 | 12.0 | 0 | 100 | 0.10 | 0.70 |
| 14 | 88.0 | 12.0 | 0 | 100 | 0.10 | 0.70 |
| 15 | 88.0 | 12.0 | 0 | 100 | 0.10 | 0.02 |
| 16 | 88.0 | 12.0 | 0 | 100 | 0.10 | 0.99 |
| 101 | 74.3 | 25.0 | 0 | 99.3 | 0.10 | 0.70 |
| 102 | 85.0 | 4.8 | 0 | 89.8 | 0.10 | 0.70 |
| 103 | 67.0 | 12.0 | 1 | 79.0 | 0.10 | 0.70 |
| 104 | 86.7 | 12.0 | 1 | 98.7 | 0.00 | 0.70 |
| 105 | 86.7 | 12.0 | 1 | 98.7 | 0.10 | 0.70 |
| 106 | 86.7 | 12.0 | 1 | 98.7 | 0.23 | 0.70 |
| 107 | 86.7 | 12.0 | 1 | 98.7 | 0.10 | 0.70 |
| 108 | 87.7 | 12.0 | 0 | 99.7 | 0.10 | 0.70 |
| 109 | 87.7 | 12.0 | 0 | 99.7 | 0.10 | 0.70 |
| 110 | 87.7 | 12.0 | 0 | 99.7 | 0.20 | 1.20 |
| 111 | 87.7 | 12.0 | 0 | 99.7 | 0.20 | 0.40 |
| 112 | 87.7 | 12.0 | 0 | 99.7 | 0.31 | 0 |

<Mode of Tungsten Carbide Particles Based on Area in Particle Size Distribution, Cobalt Content of Binder Phase. D50 of Binder Phase. D10/D90 of Binder Phase. Composition of Second Hard Phase, and D50 of Second Hard Phase>

The mode of tungsten carbide particles based on an area in particle size distribution, the cobalt content of the binder phase, the D50 of the binder phase, the D10/D90 of the binder phase, the composition of the second hard phase, and the D50 of the second hard phase in the cemented carbide of each sample were measured by the method described in Embodiment 1. The results are shown in Table 5.

TABLE 5

| | WC particles | | | | | |
|---|---|---|---|---|---|---|
| | Mode in | Binder phase | | | | |
| | particle size | Co | | | Second hard phase | |
| Sample | distribution | content | D50 | | | D50 |
| No. | μm | % | μm | D10/D90 | Composition | μm |
| 1 | 0.28 | 100 | 0.15 | 0.32 | — | — |
| 2 | 0.62 | 100 | 0.15 | 0.32 | TiNbC | 0.008 |
| 3 | 0.44 | 100 | 0.15 | 0.32 | TiNbN | 0.008 |
| 4 | 0.28 | 100 | 0.15 | 0.32 | TiNbCN | 0.080 |
| 5 | 0.75 | 100 | 0.15 | 0.32 | TiNbCN | 0.020 |
| 6 | 0.28 | 53 | 0.15 | 0.32 | — | — |
| 7 | 1.08 | 100 | 0.11 | 0.38 | — | — |
| 8 | 0.78 | 100 | 0.12 | 0.36 | — | — |
| 9 | 0.77 | 100 | 0.14 | 0.33 | — | — |
| 10 | 0.76 | 100 | 0.14 | 0.32 | — | — |
| 11 | 0.73 | 100 | 0.13 | 0.30 | — | — |
| 12 | 0.28 | 100 | 0.28 | 0.27 | — | — |
| 13 | 0.21 | 100 | 0.15 | 0.32 | — | — |
| 14 | 0.21 | 100 | 0.15 | 0.32 | — | — |
| 15 | 0.28 | 100 | 0.15 | 0.32 | — | — |
| 16 | 0.21 | 100 | 0.15 | 0.32 | — | — |
| 101 | 0.28 | 100 | 0.15 | 0.32 | — | — |
| 102 | 0.28 | 100 | 0.15 | 0.32 | — | — |
| 103 | 0.21 | 100 | 0.15 | 0.32 | TiNbCN | 0.008 |
| 104 | 0.28 | 100 | 0.15 | 0.32 | TiNbN | 0.008 |
| 105 | 0.28 | 100 | 0.15 | 0.25 | TiNbN | 0.008 |
| 106 | 0.28 | 100 | 0.15 | 0.32 | TiNbCN | 0.080 |
| 107 | 0.28 | 41 | 0.15 | 0.32 | TiNbN | 0.020 |
| 108 | 0.28 | 100 | 0.09 | 0.23 | — | — |
| 109 | 0.28 | 100 | 0.40 | 0.50 | — | — |
| 110 | 0.28 | 100 | 0.15 | 0.32 | — | — |
| 111 | 0.28 | 100 | 0.20 | 0.32 | — | — |
| 112 | 0.28 | 100 | 0.35 | 0.32 | — | — |

<A_{V}/A_{Co} and A_{Cr}/A_{Co} in Interface Region A, and By/Bro and B_{Cr}/B_{Co} in Interface Region C>

The A_{V}/A_{Co} and the Act/A_{Co} in the interface region A and the B_{V}/B_{Co} and the B_{Cr}/B_{Co} in the interface region C in the cemented carbide of each sample were measured by the method described in Embodiment 1. The results are shown in Table 6.

TABLE 6

| | | | | | Cutting test |
|---|---|---|---|---|---|
| Sample | Interface region A | | Interface region C | | Cutting |
| No. | A_{V}/A_{Co} | A_{Cr}/A_{Co} | B_{V}/B_{Co} | B_{Cr}/B_{Co} | length (m) |
| 1 | 0.20 | 0.90 | 0.90 | 1.50 | 45 |
| 2 | 0.20 | 0.90 | 0.90 | 1.50 | 43 |
| 3 | 0.20 | 0.90 | 0.90 | 1.50 | 42 |
| 4 | 0.01 | 0.90 | 0.01 | 1.50 | 43 |
| 5 | 0.45 | 0.90 | 1.10 | 1.32 | 49 |
| 6 | 0.20 | 0.90 | 0.90 | 1.50 | 44 |
| 7 | 0.20 | 0.90 | 0.90 | 1.50 | 39 |
| 8 | 0.46 | 1.80 | 1.00 | 0.40 | 36 |
| 9 | 0.44 | 1.80 | 0.90 | 0.40 | 35 |
| 10 | 0.40 | 1.70 | 0.90 | 0.30 | 36 |
| 11 | 0.38 | 1.60 | 0.70 | 0.20 | 36 |
| 12 | 0.20 | 0.90 | 0.90 | 1.50 | 44 |
| 13 | 0.45 | 1.70 | 0.11 | 1.50 | 39 |
| 14 | 0.11 | 0.80 | 0.35 | 1.10 | 38 |
| 15 | 0.20 | 0.01 | 0.90 | 0.01 | 37 |
| 16 | 0.20 | 1.90 | 0.90 | 1.98 | 39 |
| 101 | 0.20 | 0.90 | 0.90 | 1.50 | 22 |
| 102 | 0.20 | 0.90 | 0.90 | 1.50 | 26 |
| 103 | 0.20 | 0.90 | 0.90 | 1.50 | 28 |
| 104 | 0.00 | 0.90 | 0 | 1.50 | 29 |
| 105 | 0.60 | 2.10 | 1.30 | 2.10 | 21 |
| 106 | 0.20 | 0.90 | 0.90 | 1.50 | 28 |
| 107 | 0.20 | 0.90 | 0.90 | 1.50 | 25 |
| 108 | 0.20 | 0.90 | 0.90 | 1.50 | 29 |
| 109 | 0.20 | 0.90 | 0.90 | 1.50 | 22 |
| 110 | 0.20 | 0.90 | 1.40 | 2.50 | 22 |
| 111 | 0.67 | 0.26 | 1.10 | 1.10 | 19 |
| 112 | 0.71 | 0 | 1.50 | 0 | 18 |

### [Cutting Test]

A round bar formed of the cemented carbide of each sample was processed to produce a four-blade ball end mill with a blade diameter of +6 mm. The ball end mill was used to perform shoulder milling of a workpiece formed of hardened steel (58-62 HRC). The processing conditions were a rotation speed n 6500/min, a feed rate Vf 1500 mm/min, a cutting depth (axial direction) ap 0.12 mm, a cutting depth (radial direction) ae 0.12 mm, and air blow. The cutting length until the flank face wear amount of the cutting tool reached 100 μm was measured. When the cutting length was 35 m or more, it was determined that the tool life is long. It is shown that the longer the cutting length, the longer the tool life. The results are shown in the “Cutting length” column of the “Cutting test” in Table 6. The above processing conditions correspond to rough processing of a die steel.

### DISCUSSION

The cemented carbides and the cutting tools of Sample 1 to Sample 16 correspond to the Examples. It was confirmed that these cutting tools had a long tool life.

The cemented carbides and the cutting tools of Sample 101 to Sample 112 correspond to the Comparative Examples. These cutting tools had an insufficient tool life.

The embodiments and the Examples of the present disclosure have been described as above, and it is also planned from the beginning to appropriately combine the configurations of the embodiments and the Examples described above and to modify these in various ways.

The embodiments and the Examples disclosed this time should be considered to be illustrative in all respects and non-limiting. The scope of the present invention is defined by the Claims, not by the above embodiments and Examples, and is intended to include all modifications within the meaning and scope equivalent to the Claims.

### REFERENCE SIGNS LIST

1 First tungsten carbide particle; 2 Second tungsten carbide particle; 3 Binder phase; R Measurement region; 10 Cutting tool; 11 Cutting edge.

1. A cemented carbide comprising a first hard phase consisting of a plurality of tungsten carbide particles and a binder phase containing cobalt, wherein
a total content of the first hard phase and the binder phase of the cemented carbide is 80.0% by volume or more,
a content of the binder phase of the cemented carbide is 5.0% by volume or more and 21.0% by volume or less,
a cobalt content of the binder phase is 50% by mass or more,
a 50% cumulative particle diameter D50 of the binder phase based on an area is 0.10 μm or more and 0.30 μm or less,
a ratio D10/D90 of a 10% cumulative particle diameter D10 of the binder phase based on an area to a 90% cumulative particle diameter D90 of the binder phase based on an area is 0.26 or more and 0.40 or less,
a vanadium content of the cemented carbide is 0.01% by mass or more and 0.20% by mass or less,
a chromium content of the cemented carbide is 0.01% by mass or more and 1.00% by mass or less,
the tungsten carbide particles include a first tungsten carbide particle having a crystal plane of {11-20} and a second tungsten carbide particle that exists adjacent to the crystal plane of {11-20},
in an interface region A between the crystal plane of {11-20} of the first tungsten carbide particle and the second tungsten carbide particle, a ratio A_{V}/A_{Co} of a maximum value A_{V} of the vanadium content to a maximum value A_{Co} of the cobalt content is 0.01 or more and 0.5 or less,
in the interface region A, a ratio A_{Cr}/A_{Co} of a maximum value A_{Cr} of the chromium content to the maximum value A_{Co} of the cobalt content is 0.01 or more and 2.0 or less,
the tungsten carbide particles include a third tungsten carbide particle having a crystal plane of {0001} and a fourth tungsten carbide particle that exists adjacent to the crystal plane of {0001},
in an interface region C between the crystal plane of {0001} of the third tungsten carbide particle and the fourth tungsten carbide particle, a ratio B_{V}/B_{Co} of a maximum value B_{V} of the vanadium content to a maximum value B_{Co} of the cobalt content is 0.01 or more and 1.2 or less, and
in the interface region C, a ratio B_{Cr}/B_{Co} of a maximum value B_{Cr} of the chromium content to the maximum value B_{Co} of the cobalt content is 0.01 or more and 2.0 or less.

2. The cemented carbide according to claim 1,
wherein the A_{V}/A_{Co} is 0.01 or more and 0.3 or less,
the A_{Cr}/A_{Co} is 0.01 or more and 1.5 or less,
the B_{V}/B_{Co} is 0.4 or more and 1.2 or less, and
the B_{Cr}/B_{Co} is 0.5 or more and 2.0 or less.

3. The cemented carbide according to claim 1,
wherein the cemented carbide further comprises a second hard phase,
the second hard phase consists of at least one first compound selected from the group consisting of TiNbC, TiNbN, and TiNbCN, and
a 50% cumulative particle diameter D50 of the second hard phase based on an area is 0.003 μm or more and 0.05 μm or less.

4. The cemented carbide according to claim 1, wherein a mode of the tungsten carbide particles based on an area in particle size distribution is 0.2 μm or more and 0.8 μm or less.

5. A cutting tool comprising a cutting edge consisting of the cemented carbide according to claim 1.
